(19) United States
(12) Patent Application Publication
(10) Pub. No.: US 2009/0114192 A1
(43) Pub. Date: May 7, 2009

(54) Injector for accumulator injector system

(76) Inventors: Stefan Espig, Stuttgart (DE); Bernhard Jutz, Brugstetten (DE); Johannes Leweux, Esslingen (DE); Gregor Renner, Stuttgart (DE); Heiko Sass, Tamm (DE); Nicole Schlegl, Rudersberg (DE); Holger Stark, Allmersbach im Tal (DE); Thomas Stolk, Kirchheim (DE); Andreas Vortmeier, Waiblingen (DE)

Correspondence Address: KLAUS J. BACH, 4407 TWIN OAKS DRIVE, MURRYSVILLE, PA, 15668, US

(21) Appl. No.: 12/284,149

(22) Filed: Sep. 18, 2008

Related U.S. Application Data
(63) Continuation-in-part of application No. PCT/EP2007/002336, filed on Mar. 16, 2007.

(30) Foreign Application Priority Data
Mar. 21, 2006 (DE) 10 2006 012 845.1

(51) Int. Cl. F02M 63/00

(52) U.S. Cl. 123/447; 123/472

(57) ABSTRACT

In an injector for an accumulator injection system comprising an injector having an injector housing with an injection nozzle and an actuator for operating the injection nozzle arranged in a fuel-filled pressure space of the injector housing wherein the actuator includes a piezoelectric element disposed between an actuator head and an actuator the base with a fuel-tight casing at least partially surrounding the actuator head and the actuator base, the casing is engaged in a sealing fashion by a first annular element with the actuator base and by a second annular element with the actuator head.

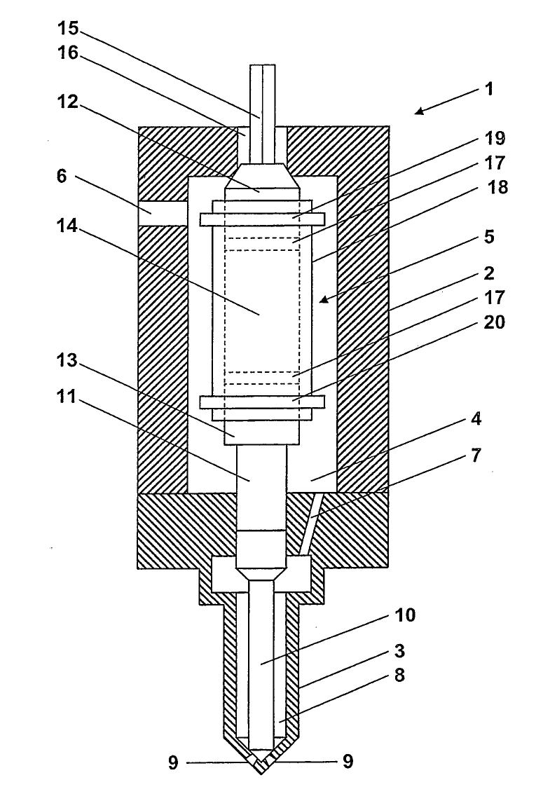

This is a Continuation-In-Part Application of pending international application PCT/EP2007/002336 filed Mar. 16, 2007 and claiming the priority of German application 10 2006 012 845.1 filed Mar. 21, 2006.

### BACKGROUND OF THE INVENTION

The present invention relates to an injector for accumulator injection systems including an injector housing with a fuel-filled pressure space and an actuator comprising a piezo electric element in a fuel-tight casing.

The laid-open specification DE 103 48 926 A1 discloses an injector for accumulator injection systems. The injector sprays fuel from an accumulator directly into a combustion chamber of an internal combustion engine. The injector has an injector housing and an injection nozzle which is connected to the injector housing. Provided in the injector is a pressure space into which fuel flows from the accumulator. From the pressure space, the fuel flows to the injection nozzle. Arranged in the pressure space is a piezoelectric actuator disposed between an actuator base and an actuator head. The actuator is connected by means of the actuator base to the injector housing and by means of the actuator head to the valve element. The actuator is surrounded by a casing which is held on the actuator by means of labyrinths, which engage into one another, of the actuator head and the casing or of the actuator base and of the casing, which casing seals off the piezoelectric element with respect to the fuel in the pressure space. It is disadvantageous here that the fuel can work its way through the labyrinths, as a result of which short circuits can occur in the actuator.

It is the principal object of the present invention to provide an injector for accumulator injection systems with an actuator which is disposed in a pressure space and which is reliably sealed off with respect to the fuel in the pressure space.

### SUMMARY OF THE INVENTION

In an injector for an accumulator injection system including an injector having an injector housing with an injection nozzle and an actuator for activating the injection nozzle arranged in a fuel-filled pressure space of the injector housing wherein the actuator includes a piezoelectric element disposed between an actuator head and an actuator the base with a fuel-tight casing at least partially surrounding the actuator head and the actuator base, the casing is held in sealing engagement by a first annular element with the actuator base and by a second annular element with the actuator head.

Preferably, the casing fully surrounds the piezoelectric element and also partially surrounds the actuator head and the actuator base. The first annular element thus surrounds the casing in such a way that the casing is pressed circumferentially by the first annular element against the actuator base and into a sealing relationship therewith. The second annular element surrounds the casing in such a way that the casing is pressed by the second annular element circumferentially into sealing relationship with the actuator head. The annular elements advantageously exert a circumferential contact pressure on the casing, as a result of which the casing is held in a sealing engagement with the actuator base and the actuator head and no fuel can work its way through the seal between the casing and the actuator base or the actuator head to the piezoelectric element.

In one embodiment of the invention, the casing is embodied as a shrink hose. The shrink hose permanently reduces its circumference when heated, and therefore is wrapped uniformly and tightly around the actuator. Projections of the casing or cavities between the casing and the actuator are expediently avoided in particular at the actuator base and at the actuator head, such that a uniform contact pressure can be exerted by the annular elements on the actuator base and the actuator head and the interposed casing, as a result of which the sealing effect of the casing can be further increased.

In a further embodiment of the invention, the casing is adhesively bonded to the actuator head and/or to the actuator base. It is advantageously possible by means of the adhesive bond to obtain a further increase in the leak tightness of the casing.

In a further embodiment of the invention, the annular elements consist of a shape-memory alloy. The annular elements consisting of a shape-memory alloy permanently reduce their circumference as a result of a change in temperature, whereby the annular elements can be wrapped around the casing. The casing can advantageously be held by the annular elements in engagement with the actuator base and on the actuator head with a uniform circumferential contact pressure, and the impermeability of the casing can therefore be further increased.

The invention will become more readily apparent from the following description of a physical exemplary embodiment of the invention illustrated in simplified form in the accompanying drawing.

### BRIEF DESCRIPTION OF THE DRAWING

The sole FIGURE shows schematically a simplified exemplary embodiment of an injector for accumulator injection systems.

### DETAILED DESCRIPTION OF AN EXEMPLARY EMBODIMENT

The FIGURE shows, in a longitudinal sectional view, an injector 1 with an injector housing 2 and an injection nozzle 3 which is attached to the injector housing 2. An actuator 5 is provided in a pressure space 4 of the injector housing 2, which actuator 5 activates the injection nozzle 3. The pressure space 4 is connected by means of a fuel supply line 6 to an accumulator (not illustrated) of the accumulator injection system. Fuel is fed into the accumulator by means of a high-pressure pump and is stored in the accumulator under high pressure. The highly pressurized fuel can flow out of the pressure space 4 via a high-pressure supply line 7 into a nozzle space 8 of the injection nozzle 3. The injection nozzle 3 has at least one opening 9 for ejecting fuel, preferably a plurality of openings for ejecting fuel, which openings 9 connect the nozzle space 8 to a combustion chamber (not illustrated) of an internal combustion engine. The openings 9 for ejecting fuel can be unblocked by a valve element 10, in particular a valve needle 10, such that the fuel can be ejected directly out of the openings 9 into the combustion chamber of the internal combustion engine. The valve needle 10 is connected by means of a transmission element 11 to the actuator 5, with the transmission element 11 transmitting length variations of the actuator 5 to the valve needle 10, such that the injection openings 9 can be blocked or unblocked by the valve needle 10.

The actuator 5 includes a piezoelectric element 14 which is arranged between an actuator base 12 and an actuator head 13, and which receives control signals from a control unit by means of electrical lines 15. The actuator 5 is supported in the injector housing 2 by means of the actuator base 12 and the actuator head 13 is connected to the valve needle 10 via the transmission element 11. The electrical lines 15 extend out of the injector housing 2 through the actuator base 12 and through an opening 16 which extends into the pressure space 4 but which is sealed off by the actuator base 12. The piezoelectric element 14 is electrically insulated with respect to the actuator base 12 and the actuator head 13 by means of support plates 17 and is sealed off with respect to the fuel in the pressure space 4 by means of a fuel-tight or fuel-impervious casing 18, as a result of which electrical short circuits in the electrical components of the actuator 5 are prevented.

The casing completely surrounds the piezoelectric element 14 with the support plates 17, the piezoelectric element being supported at the actuator base 12 and at the actuator head 13. For this purpose, the casing 18 also surrounds partially the actuator base 12 and partially the actuator head 13, such that the casing 18 can be pressed circumferentially against the preferably cylindrical actuator base 12 in a sealing fashion by means of a first annular element 19. It is also pressed circumferentially against the preferably cylindrical actuator head 13 in a sealing fashion by means of a second annular element 20. Preferably, the annular elements 19, 20 press a circumferential, closed annular surface of the casing 18 against the actuator base 12 or the actuator head 13, as a result of which the piezoelectric element 14 is reliably sealed off with respect to the fuel in the pressure space 4 and is reliably held between the annular element 19 on the actuator base 12 and the annular element 20 on the actuator head 13.

The fuel-tight casing 18 consists of a shrink hose which reduces its circumference as a result of a supply of heat and can thereby be wrapped uniformly around the actuator 5, in particular at the actuator base 12 and at the actuator head 13, without accumulations of the casing 18 and/or cavities being formed between the casing 18 and the actuator 5. It is also advantageous that the shrink hose 18 bears with a circumferentially uniform wall thickness against the actuator head 12 and against the actuator head 13, such that the contact pressure exerted by the annular elements 19, 20 on the actuator base 12 and on the actuator head 13 is uniform, as a result of which the impermeability of the casing 18 can be increased. Furthermore, the casing or the shrink hose 18 can be adhesively bonded to the actuator 5, in particular to the actuator base 12 and/or to the actuator head 13, as a result of which it is possible to obtain a further increase in the impermeability of the casing or of the shrink hose 18.

The annular elements 19, 20 may be composed of a shape-memory alloy. Shape-memory alloys or memory metals can change their shape on the basis of a temperature-dependent lattice conversion of two different crystal structures. The annular elements 19, 20, if composed of the shape-memory alloy, may reduce their circumference under the action of a temperature change, as a result of which the annular elements 19, 20 are wrapped around the casing 18 and the actuator base 12 and actuator head 13. It is advantageous that the change in shape or the reduction of the circumference of the annular elements 19, 20 is uniform and therefore a uniform contact pressure of the annular elements 19, 20 on the casing 18 is obtained, as a result of which the impermeability of the casing 18 can be further increased.

The injector 1 according to the invention is characterized by an improved design which permits simple assembly and which reliably seals off the piezoelectric element 14 and the electrical lines 15 with respect to the fuel in the pressure space 4.

What is claimed is:

1. An injector for accumulator injection systems, comprising an injector housing (2) including an injection nozzle (3), and a fuel-filled pressure space (4), an actuator (5) having an actuator head (13) and an actuator base (12), arranged in the fuel-filled pressure space (6) of the injector housing (2) for actuating the injection nozzle (3), the actuator (5) comprising a piezoelectric element (14) arranged between the actuator head (13) and the actuator base (12), a fuel-tight casing surrounding the actuator at least between the actuator head (13) and the actuator base (12), and a first annular element (19) extending around the actuator base (12) and a second annular element (20) extending around the actuator head (13) for holding the casing (18) in sealing engagement with the actuator (15).

2. The injector as claimed in claim 1, wherein the casing (18) is in the form of a shrink hose.

3. The injector as claimed in claim 1, wherein the casing (18) is adhesively bonded to at least one of the actuator base (12) and the actuator head (13).

4. The injector as claimed in claim 1, wherein the first and second annular elements (19, 20) consist of a shape-memory alloy.
